(19) United States
(12) Patent Application Publication
(10) Pub. No.: US 2018/0025429 A1
(43) Pub. Date: Jan. 25, 2018

(54) SYSTEM AND METHOD FOR IDENTIFYING POTENTIAL MORTGAGE BORROWERS

(71) Applicant: David Avrick, Santa Barbara, CA (US)

(72) Inventor: David Avrick, Santa Barbara, CA (US)

(21) Appl. No.: 15/703,965

(22) Filed: Sep. 13, 2017

Related U.S. Application Data
(63) Continuation of application No. 14/025,972, filed on Sep. 13, 2013, now abandoned.

(51) Int. Cl. G06Q 40/06

(52) U.S. Cl. CPC G06Q 40/06

(57) ABSTRACT

A method for identifying potential mortgage borrowers comprises the steps of collecting actual data relating to client information and real estate listings, simultaneously determining whether a client listed therein may be in need of a new mortgage loan, and notifying one or more third-parties of such determination. A system for running the aforementioned methods comprises a computer readable medium, an input means, a processor, and a display module, which system is capable of executing various subroutines and user commands to perform the methods.

### CROSS-REFERENCE TO RELATED APPLICATIONS

The present application is a continuation of and claims priority under 35 U.S.C. §120 upon pending U.S. patent application Ser. No. 14/025,972, filed on Sep. 13, 2013, the disclosure of which is incorporated by reference.

### FIELD OF THE DISCLOSURE

The present disclosure relates to a system and method for identifying potential borrowers, and, more particularly, to a system and method for identifying potential mortgage borrowers.

### BACKGROUND

The performance of specific mortgage-backed securities depends largely on the fulfillment of payment obligations by the borrower. As such, if the borrower pays off his or her loan balance on time and does not default, the investor maintaining a security over his or her loan may enjoy a financial gain. In particular, investors derive their investment profits from the scheduled payments on a loan's principal and interest balances as well as any prepayments made to the principal balance. Contrastingly, if the borrower fails to pay or his or her loan balance on time and thereby defaults on the loan, the investor may face a financial loss. For example, if the loan is defaulted upon and the respective real property is subsequently foreclosed upon, the investor may lose a portion or all of his or her investment in the security over that real property.

Because investing in mortgage-backed securities requires putting up a financial stake, which usually is significant, it is important that investors be made aware of their investments' performances at all times. If a security is performing poorly, investors should be notified of such so that they may choose to sell off or otherwise limit their investment thereon to prevent themselves from losing money. Similarly, if a security is performing well, investors should be notified so that they may choose to invest in that security or otherwise maintain their investment thereon. As such, it is very important that investors receive timely updates as to the performance of their various mortgage-backed security investments.

However, existing solutions in the field merely rely on financial estimates and approximations in order to evaluate the performance of a particular security or pool thereof. These solutions often use developed algorithms to map out projections for each investment based in part on past performance and the real estate market as a whole. Unfortunately, though, because these projections are based largely on estimates and approximations, there is a potential margin of error on each performance projection, which margin of error may be substantial. As a result, investors cannot be made sufficiently aware of the accurate performance or financial status of their securitized investments until a retrospective report is compiled from such past performance.

The fact remains that investors must be aware of the performance of these securities in order to make informed decisions as to whether to maintain or sell the investments, or whether to invest in a new security at all. Thus, existing solutions fail to provide investors with enough information to determine with a sufficient degree of confidence how mortgage-backed securities are performing, and, specifically, to determine and provide the potential profit and potential deficit associated with investing or maintaining an investment in a mortgage-backed security or a pool thereof. The present inability in the field to determine accurately calculated performance values means that investors cannot make fully informed decisions on mortgage-backed security investments, and therefore that their risk of losing their investment stake is higher than it needs to be.

Further, and as is apparent, the greater the number of mortgage-backed securities there are, the greater the number of investment opportunities there will be. Accordingly, it is important that potential mortgage borrowers be identified by financial lending institutions so that more securities may be compiled, which in turn facilitates the ability of investors to invest more in such securities. Many mortgage borrowers decide to enter into mortgage loan transactions independent of outside sources; however, the number of potential borrowers would be increased through the targeted advertising of mortgage loan opportunities to individuals who and entities that either remain undecided on whether or not to enter into such a loan transaction or have not considered the prospect at all. Such targeted advertising may have the effect of causing potential borrowers to decide to enter into mortgage loan transactions.

Consequently, there exists a need for a system and method that uses actual valuation, mortgage, listing, and client data to identify potential mortgage borrowers for entering into new mortgage loan transactions.

### SUMMARY OF THE DISCLOSURE

In view of the foregoing disadvantages of the prior art, a system and method for identifying potential mortgage borrowers configured to include all the advantages of the prior art and to overcome the drawbacks inherent therein is provided. It is an object of the present disclosure to determine whether a client may be in need of a new mortgage loan, which accurate data may be updated at any time in order to evaluate investment performance and borrower identification using current information.

The system and method involve collecting actual data relating to mortgage loan transactions and real property valuations and comparing that data to determine whether the property value for a particular real property listed for sale is greater than or less than a current mortgage balance. The system and method further involve collecting client data and comparing that data to real estate listing data to determine whether a client listed therein needs or may soon need a new mortgage loan or may otherwise be purchasing or financing a new real property.

In an embodiment, a method for identifying potential mortgage borrowers comprises the steps of receiving listing data that may include at least one listing address, obtaining client data that may include at least one client name and/or client address, storing the client data and listing data in at least one database, and comparing the client data and listing data to determine whether a client listed in the client data may be in need of a new mortgage loan. The listing data may include at least a listing address. Comparing the client data and the listing data involves matching a client address corresponding to a client name of the client data with a listing address of the listing data. The method further allows a user to repeat any of the steps to reflect updated data. The method may further comprise the step of notifying at least one third-party that a client of the client data may be in need of a new mortgage loan or related goods and services.

In an embodiment, a system for identifying potential mortgage borrowers comprises a computer readable medium, an input means, a processor, and a display module. The computer readable medium stores the aforementioned valuation data, mortgage data, listing data, and client data within at least one database. The input means allows a user to manipulate the valuation data, the mortgage data, the listing data, the client data, and the at least one database. The processor executes various routines and commands for manipulating the valuation data, mortgage data, listing data, and client data. The input means and processor are capable of providing instantaneous identification of potential borrowers as described more specifically herein. The display module may be any display device for displaying the valuation data, mortgage data, listing data, client data, at least one database, financial status, and performance rating.

In still a further embodiment, the system executes a series of commands from the user for running all or part of at least one of the above methods.

These together with other aspects of the present disclosure, along with the various features of novelty that characterize the present disclosure, are pointed out with particularity in the claims annexed hereto and form a part of the present disclosure. For a better understanding of the present disclosure, its operating advantages, and the specific objects attained by its uses, reference should be made to the accompanying drawings and detailed description in which there are illustrated and described exemplary embodiments of the present disclosure.

### DESCRIPTION OF THE DRAWINGS

The advantages and features of the present disclosure will become better understood with reference to the following detailed description and claims taken in conjunction with the accompanying drawings, wherein like elements are identified with like symbols, and in which:

FIG. 1 shows an exemplary diagram of the sources from which data is retrieved and computer systems involved in the disclosed methods in accordance with an exemplary embodiment of the present disclosure;

FIG. 2 shows an exemplary flow chart illustrating the steps of the disclosed method for identifying potential mortgage borrowers in accordance with an exemplary embodiment of the present disclosure; and

FIG. 3 shows an exemplary computer system diagrammed hierarchically in table view in accordance with an exemplary embodiment of the present disclosure.

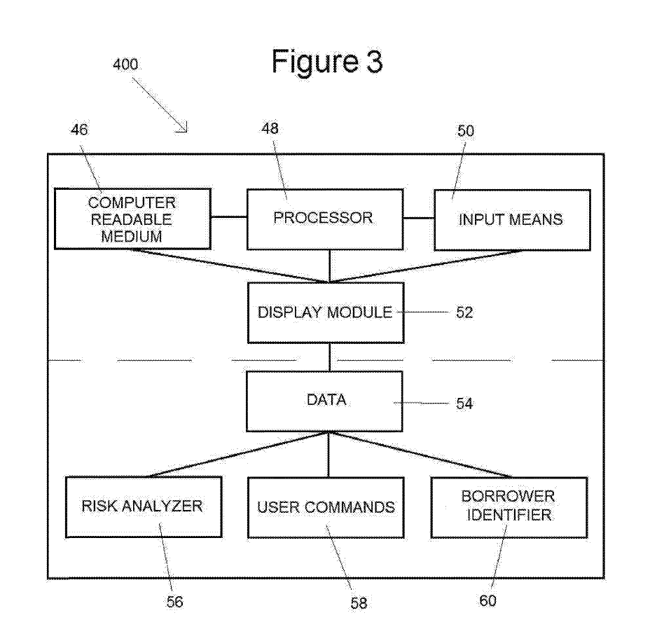

Like reference numerals refer to like parts throughout the description of several views of the drawings.

### DETAILED DESCRIPTION OF THE DISCLOSURE

The best mode for carrying out the present disclosure is presented in terms of its preferred embodiments, herein depicted in the accompanying figures. The preferred embodiments described herein detail for illustrative purposes are subject to many variations. It is understood that various omissions and substitutions of equivalents are contemplated as circumstances may suggest or render expedient, but are intended to cover the application or implementation without departing from the spirit or scope of the present disclosure.

The terms “a” and “an” herein do not denote a limitation of quantity, but rather denote the presence of at least one of the referenced items.

The present disclosure comprises a system and method for identifying potential mortgage borrowers.

In an embodiment, a method for identifying potential mortgage borrowers allows a user to determine whether the owner of a real property listed for sale may be in need of a new mortgage loan. The method similarly involves collecting actual data, such as the listing data including a listing address, and client data relating to a list comprising client names and corresponding addresses, which data is also collected from various records for accuracy. In an embodiment, the user compares the listing address prescribed in the listing data with the client addresses of the client data to determine whether a client named on the client list may be selling his or her real property. The results of this comparison may be used by third parties, such as financial lending institutions, to provide targeted marketing for mortgage loan offers to such clients. The results may further be used by other third parties to provide targeted marketing for related goods and services that may be desired or needed by someone buying and/or selling a real property.

In an embodiment, a system, such as a computer system, is capable of executing various routines and user commands to cause the aforementioned methods to be performed. The system may allow the user to retrieve all of the collected, actual data online by connecting to different servers, or it may receive such actual data directly from the user manually inputting or transferring it into the system's computer readable medium. The system may include at least one database within which all of the data may be organized and stored. The system allows the user to manipulate the data using an input means, which preferably may be a keyboard and mouse configuration, but may instead be of any configuration sufficient to review, edit, and otherwise use such data. The processor of the system causes all of the user commands to be executed and may as well execute one or more subroutines, which commands and subroutines may be directed to the performance of methods of identifying potential mortgage borrowers. Based at least in part of the data collection and processing speeds of a computer and at least in part on the speed at which a computer may execute user commands and/or execute subroutines, the processor of the system and the system itself may produce effectively instantaneous identification of potential mortgage borrowers. The system includes a display module for providing the user with a visual representation of all of the data, the manipulations made via the input means, and the subroutines and user commands executed thereon.

It will be apparent that the disclosed methods may apply to either or both potential residential mortgage borrowers and potential commercial mortgage borrowers, and further that the term “real property” as herein and hereafter used may refer to either or both of a residential real property and a commercial real property. Accordingly, and as will be shown, the disclosed system and methods are designed to work with both residential borrowers and commercial borrowers.

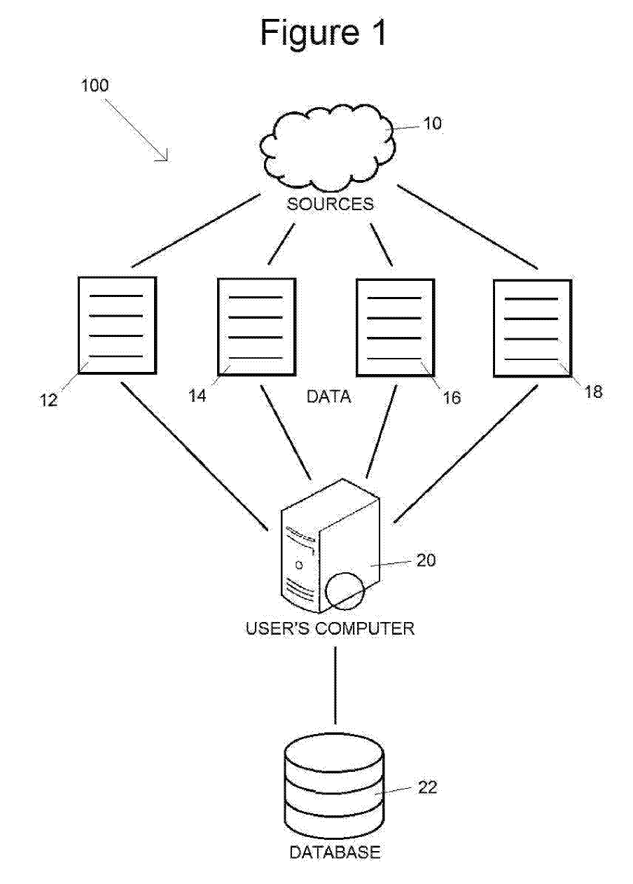

Referring now to FIG. 1, a diagram is shown at 100 as indicating connections between the disclosed system (hereinafter referred to as “the user's computer”) 20 and the various sources 10 from which the valuation data 12, mortgage data 14, listing data 16, and client data 18 are retrieved, which various sources 10 may be computer servers, written or printed materials, or oral conveyances. Preferably, the retrieved data will be embodied in some written, printed, or digital format at the time at which it is retrieved; however, it will be apparent that data received orally, such as that via telephonic or in person conversation, will be sufficient as long as it is accurate. In an embodiment where the data is retrieved from one or more servers, the user would log onto the server containing the records such as a website, which website, for example, may be a county clerk's office website or real estate listing website, and search for and thereafter download the desired data onto the computer readable medium of the user's computer 20. In an embodiment where the data is retrieved from a written or printed material, the written or printed material may be scanned or manually entered into computer readable medium of the user's computer 20. In an embodiment where the data is retrieved by oral conveyance, the data may be manually entered into the computer readable medium of the user's computer 20.

The disclosed methods (described in detail below) require accurate or reliable data as input. Specifically, the methods require the retrieval of valuation data 12, mortgage data 14, listing data 16, and client data 18. The valuation data 12 is any data that conveys the value of the real property in question. In an embodiment, the valuation data 12 may comprise at least one of a listing price (such as that from a real estate sales listing), a fair market valuation (such as that conducted by a marketing or similar agency or firm), an appraisal amount (such as that which is determined by a real property appraiser), and a real estate comparison valuation (such as that from a real estate agency). The mortgage data 14 provides important information relating to a mortgage loan transaction for the real property in question. In an embodiment, the mortgage data 14 may comprise at least one of an original loan amount (such as the total amount of the loan as executed), a purchase amount (such as the total price paid for the real property), an execution date (such as the date the mortgage was entered into), an interest rate (which rate may be static or dynamic depending on the specific terms of the mortgage loan transaction), and a loan term (which may, for example, be fifteen or thirty years in length). The client data 18 indicates the name and/or address for at least one customer or client of a business. In an embodiment, the client data may comprise a list of customer's names and addresses, which customers have at least once patronized the business from which the list derived. The listing data 16 contains a plurality of real estate sales listings, and, specifically, conveys the addresses corresponding to such real estate sales listings. In an embodiment, the listing data 16 may comprise one or more addresses, which may pertain to residential or commercial properties, and may further comprise the legal description and/or commonly known as name for the real property.

In order for the disclosed methods to be performed properly, the retrieved data must be accurate or reliable. Thus, the various sources 10 from which such data is retrieved must be official or sufficiently trustworthy. For example, and preferably, where the real property in question is listed for sale, the valuation data 12 may derive from the real estate agency listing the property for sale or from a similar agency; however, the valuation data 12 may similarly derive from a marketing or appraisal agency. Also by example, and also preferably, the mortgage data 14 may derive from the county clerk's office of the county in which the at least one real property in question is located. County clerk's offices are government offices that record all data relating to mortgage loan transactions on real properties and maintain those records completely. It will be apparent that the term “county clerk's office” may additionally refer to a register of deeds or similar governmental department used to maintain real property records. It will also be apparent that modern county clerk's offices maintain real property records in electronic form that allows access of such records via the internet. If necessary, the mortgage data 14 may alternatively derive from the records of the financial lending institution that entered into the mortgage loan transaction in question. Also by example, and also preferably, the listing data 16 may derive from the real estate agency retained to sell the real property in question. However, the listing data 16 may similarly be obtained from any of the plurality of third-party entities that are in the business of advertising, marketing, or otherwise displaying real property listings to the general public. Listing data 16 may be obtained from a multiple listing service, which multiple listing service includes searchable property listings from a variety of locations and agencies. An exemplary multiple listing service from which listing data 16 may be obtained is mls.com, which website provides listing data that may be searched and retrieved as part of the disclosed method. Such an exemplary listing service may be updated in real time, i.e., when properties are sold, taken off the market or added to the market. In such case, in a preferred embodiment, listing data 16 utilized by the system and method is preferably from a real-time or regularly updated data source. The client data 18 may derive from any business or other entity, which may be a financial lending institution or other entity related in any capacity to real property (which capacity, as will be discussed below, may be defined broadly to include service providers such as cable and Internet entities, moving entities, home improvement entities, and so forth). It will be apparent that, as stated above, the valuation data 12, mortgage data 14, client data 18, and listing data 16 may be derived from any source 10, be it public or private, so long as the data retrieved therefrom is accurate or reliable.

Once the valuation data 12, mortgage data 14, listing data 16, and client data 18 are retrieved and stored on the computer readable medium of the user's computer 20, the user may organize the data thereon as desired. For example, the user may choose to store all such data within one or more databases 22 for convenience. It will be apparent that the term “database” as used herein may refer to any digital file for retaining at least some of the data, which digital file may be one of a database, repository, spreadsheet, electronic document, or other suitable format. In a preferred embodiment, the valuation data 12, mortgage data 14, listing data 16, and client data 18 are all stored within a single database 22. In another embodiment, the various data are stored in multiple databases 22 within the computer readable medium of the user's computer 20.

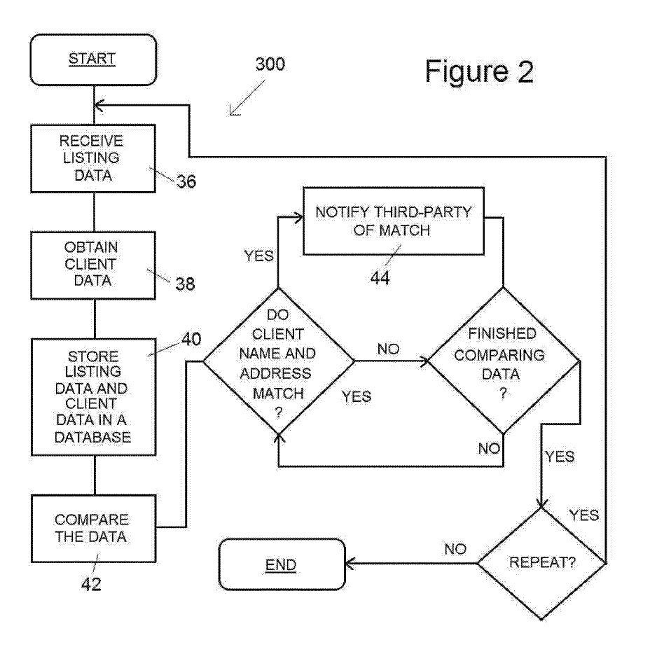

The flow chart of FIG. 2 depicts the steps of the method 300 for identifying potential mortgage borrowers. As is shown, the first step is the receiving step 36, which requires the user to receive the listing data for the at least one real property from some source, and the second step is the obtaining step 38, which requires the user to obtain the client data comprising a list of client names and corresponding addresses. The third step of the method 300 is the storing step 40 wherein the user stores the mortgage data and listing data for the at least one real property in at least one database within the computer readable medium of the user's computer.

The receiving step 36 and obtaining step 38 of this method 300 may involve the user retrieving digital, written, printed, or oral versions of the data, and the storing step 40 may involve the user transferring or manually entering that data within the at least one database. In a preferred embodiment, receiving step 36 and obtaining step 38 are performed on a computer, and receiving data may be accomplished by accessing such a multiple listing service as described above. The obtaining step may be accomplished by generating a list of client names and addresses that has been stored on the computer or has been stored remotely from the computer. In that the obtaining step may access a list of client names and addresses that resides on a computer, it will be apparent that the user can update that list of client names and addresses from time to time to provide for a customized or tailored list of client names and addresses to provide for more updated or optimized comparison of listing data against client data (such as when listing data and client data have boot been recently updated and/or customized prior to performing the comparing step 42. The receiving step 36, obtaining step 38, and storing step 40 conjunctively comprise the portion of the disclosed method wherein the user assembles and collects the data to be used therewith. Once the data has been retrieved and is stored on the user's computer, the user may proceed with the method to begin the steps involved in determining whether any clients prescribed within the client data may be in need of a new mortgage loan or may otherwise be purchasing or financing a new real property. Again, it will be apparent that the processing speed of a computer on which the method is performed (or on which the system is implemented) permits the assembly and collection of such data at a rate greater than a human can so collect such data (by manually searching county clerk hard copy records, for example) such that a significant mass of data can be collected (and compared subsequently in the comparing step 42) such that the method provides instantaneous identification of a potential mortgage borrower.

It should be noted that the comparisons throughout this disclosure between the performance capabilities between (i) humans and (ii) the system and method disclosed herein is for discussion purposes only, as the exercise of a human reviewing, or attempting to review, mortgage or real property records against a list of customers to generate a useful list of potential mortgage borrowers is not practical and is not an exercise reasonably calculated to lead to success or otherwise an exercise one of ordinary skill in the art would commence undertaking at all. Accordingly, the system and method disclosed herein provide a novel and effective solution to a previously unsolved problem. That is, there is no fundamental economic practice in place that otherwise solves the problem addressed by the present disclosure.

Accordingly, the fourth step of this method 300 is the comparing step 42, which requires the user to compare the client data and the listing data to determine whether a client listed in the client data may be putting his or her real property for sale on the market, which may infer that such client may be in need of a new mortgage loan. This determination requires the user to compare the client data against the listing data. Specifically, the user may peruse the listing data for any listing addresses that appear in the client data as well. Should the user find any listing addresses of the listing data that match a client address of the client data, the user may then isolate the client name corresponding to such client address, which client name will represent a client that may be in need of a new mortgage loan. It will be apparent that the term client as used herein may refer to an individual, a group of individuals, an entity, a group of entities, a trust or similar estate mechanism, or any combination thereof.

Comparing step 42 may also be performed on a computer, with the computer comparing the listing data and the client data to determine, for example, whether any addresses of the listing data appear as addresses of customers in the client data. It will be apparent that the processing speed of the computer that performs the method or on which the system is implemented allows this comparison to occur effectively simultaneously. Furthermore, the involvement of a computer allows comparison of significant amount of data in a short amount of time (if not instantaneously), and on an order of magnitude far greater than what human could manually compare.

Once the user has determined that a particular client of the client data may be in need of a new mortgage loan, the user may utilize such information to notify at least one third-party of such potential need during the notifying step 44. Notifying the at least one third-party in this regard requires the dissemination of at least one of the client's name and the client's address, and, in a preferred embodiment, involves the dissemination of both. The third-party being notified of such client need may be a financial lending institution such as an entity capable of entering into a new mortgage loan transaction with such client. Additionally, the third-party being notified may be one that is otherwise directly or indirectly related to the real property or mortgage industries, such as a service provider. For example, the method 300 may notify a third-party including, but not limited to, a professional moving company, a cable/Internet provider, and a construction or carpentry company that the client may be in need of a new mortgage loan and thus may be moving. Notifying these companies of the client's need for a new mortgage loan may result in those companies and providers providing targeted marketing to that client, and may in turn bring in additional business for those companies and providers. The notification step may also be performed on a computer, such as by (and effectively instantaneously) generating a mailing list with the addresses of the clients that have been identified as being in possible need of a new mortgage loan, which list can be sued by such third parties or disseminating correspondence to such identified clients. Again, the notification step, when performed by a computer, can be done on a scale and efficiency not available when performed manually by a human.

This method 300 allows the user to repeat certain steps thereof upon determining that at least one of the client data and the listing data has been updated since the method was completed. Thus, where some or all of the data has been updated, the user may repeat the receiving step 36, the obtaining step 38, and the storing step 40 to reflect those changes. The user may then respectively repeat the comparing step 42 and the notifying step 44 in order to establish the updated matching of clients' addresses to listing addresses, which updated matching updates the user as to which clients of the client data may be in need of a new mortgage loan or may otherwise be purchasing or financing a new real property. In a preferred embodiment, the method is performed immediately after at least one of the client data and listing data has been updated so as to provide instantaneous results of the identification of potential mortgage borrowers. It will be apparent that a subroutine of the computer of the method disclosed herein may be provided, which subroutine will confirm or cause an update of at least one of the client data and listing data before the method is performed.

A system capable of running the disclosed methods is diagrammed in FIG. 4, which diagram illustrates the various components of such system 400 and indicates their relation to one another. The system 400 is a computer system and therefore comprises a computer readable medium 46, an input means 50, a processor 48, and a display module 52. The computer readable medium 46 may be a random access memory, or RAM, capable of loading various programs and other routines to be executed by the processor 48 for use by the user. The computer readable medium 46 may also be a read-only memory, or ROM, such as a hard drive, capable of storing the valuation data 54, mortgage data 54, listing data 54, and client data 54 within at least one database. In a preferred embodiment, the computer readable medium comprises a RAM and a ROM. The input means 50 comprises a means for allowing the user to interact with and otherwise manipulate the various software environments on the system 400, as well as the aforementioned data and the at least one database within which such data 54 is stored. In a preferred embodiment, the input means 50 is a keyboard and mouse configuration that is operatively coupled to the system 400 via wired or wireless connections. In a further embodiment, the input means 50 may be touch-based, such as a touch-screen, which allows the user to manipulate data 54 using his or her fingers and thus without the need of additional accessories.

The processor 48 is capable of executing commands and other programs and routines, and performs any calculations that are necessary to communicate any information that may need to be transmitted between it and the other components of the system 400. It will be apparent that the processor 48 comprises a processing speed, such as a clock rate, which processing speed allows the processor 48 to execute commands and other programs and routines and perform calculations at such a rate that the results of such processing by the processor 48 are effectively rendered instantaneously. In an embodiment, the clock rate of processor 48 is on the order of at least one gigahertz. In an embodiment, the processor 48 executes pre-programmed subroutines, which subroutines may comprise executable application files. In another embodiment, the processor 48 executes user commands for executing various actions. In a preferred embodiment, the processor 48 is capable of executing both subroutines 56 and 60 and user commands 58. The display module 52 may be any screen for viewing the user interfaces embodied by the programs, routines, and commands being executed by the processor 48. In an embodiment, the display module 52 may be a computer monitor, television, projector, or other viewing device.

In an embodiment, the system 400 runs the disclosed methods by executing subroutines that pertain to the disclosed methods. When the user seeks to begin the disclosed method for identifying potential mortgage borrowers, the processor 48 may execute a borrower identifier subroutine 60 that collects the client data 54 and listing data 54 and compares them as disclosed above to determine whether any clients of the client data 54 may be in need of a new mortgage loan. The borrower identifier subroutine 60 may further notify at least one third-party of that client's or those clients' need(s), and the borrower identifier subroutine 60 is further capable of updating the client data 54 and listing data 54 and thereafter repeating the comparing and notifying steps of such method as necessary. It will be apparent that a subroutine of the system 400 may cause at least one of client data 54 and listing data 54 to be updated before identifier subroutine 60 collects such data. In such fashion, the system ensures that the data identified is current and results are instantaneous because they are based on such current data.

In a further embodiment, the system 400 runs the disclosed methods by executing a series of user commands 58 for performing the various steps thereof. For example, the processor 48 may cause a spreadsheet program to open upon such command from the user, which spreadsheet program may receive the various mortgage data, listing data, and/or client data therein, and the processor 48 may thereafter cause a separate program to open upon a further command from the user, which separate program may allow for another or the remainder of the steps of the disclosed methods to be run thereby. It will be apparent that this embodiment supports the processor 48 executing as many user commands as may be necessary in order to complete the disclosed methods, which user commands may relate to the opening of a file or software application, the saving of various data, the connection to one or more servers for retrieving data, and any other action capable of being performed by a computer. Furthermore, it will be apparent that the system disclosed herein may process amounts of data at such speeds to return identification of potential mortgage borrowers simultaneously and significantly and effectively faster than known systems and methods and if otherwise done manually by a human.

The system and method disclosed herein provide various advantages over the prior art. By using actual client data to determine whether any clients are in need of a new mortgage loan or may otherwise be purchasing or financing a new real property, the disclosed system and method provide for increasingly-accurate targeted marketing of goods and services, which directs such clients to the businesses they need and directs those businesses to new customers. Furthermore, the system and method disclosed herein provide an improvement to the functioning of a computer itself and otherwise provide a specific, discrete implementation of a way to filter data, namely, filtering data to identify potential mortgage loan borrowers. While a computer facilitates performance of the system and method disclosed herein, the disclosure provides for more than just the implementation of an abstract idea—it provides for filtering data at a speed not otherwise contemplated by the prior art and filtering of data in a useful and commercially beneficial manner, namely, to identify potential mortgage loan borrowers.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The exemplary embodiment was chosen and described in order to best explain the principles of the present disclosure and its practical application, to thereby enable others skilled in the art to best utilize the disclosure and various embodiments with various modifications as are suited to the particular use contemplated.

What is claimed is:

1. A computer-implemented method for identifying potential mortgage borrowers, the method comprising the steps of:
receiving on a non-transitory computer readable medium listing data for at least one real property, the listing data including at least one listing address;
obtaining on the non-transitory computer readable medium client data, the client data including at least one of at least one client name and at least one client address;
storing the client data and the listing data in at least one database on the non-transitory computer readable medium; and
comparing the client data and the listing data to determine whether a client of the client data may be in need of a new mortgage loan or may otherwise be purchasing or financing a new real property, wherein comparing the client data and the listing data comprises the steps of:
retrieving a listing address based on the listing data for each at least one real property; and
matching a client address corresponding to a client name with the listing address,
wherein a user may thereafter repeat at least one of said receiving step and said obtaining step in order to update the listing data and the client data respectively at any time by retrieving updated listing data and client data, and wherein the user may thereafter repeat said storing step in order to update at least one of the client data and the listing data stored in the at least one database, and
wherein the user may thereafter repeat said comparing step in order to determine whether a client address corresponding to a client name of the client data matches any of the updated listing data or whether a listing address matches any of the updated client data, and
wherein the method, when performed on a computer, is capable of comparing the client data and the listing data in order to instantaneously identify a plurality of potential mortgage borrowers, and wherein the method must be performed on a computer in order to effectuate the instantaneous identification of the plurality of potential mortgage borrowers, and
wherein prior to the performance of the method it is unknown whether a client of the client data is in need of a new mortgage loan, and wherein performing the method results in a list of identified potential mortgage borrowers, which list is stored on the non-transitory computer readable medium.

2. The method as claimed in claim 1, wherein the method further comprises the step of notifying at least one third-party that a client name of the client data matched with a listing address of the listing data may be in need of a new mortgage loan or may otherwise be purchasing or financing a new real property.

3. The method as claimed in claim 2, wherein said notifying step further comprises notifying at least one third-party that a client name of the client data matched with a listing address of the listing data may be in need of a good or service associated with purchasing or financing a new real property.

4. A system for identifying potential mortgage borrowers, the system comprising:
a computer readable medium, said computer readable medium capable of storing mortgage data, listing data and client data within at least one database;
an input means, said input means capable of allowing a user to manipulate said listing data, said client data, and said at least one database;
a processor, said processor capable of recognizing said input means, said processor capable of comparing said client data and said listing data to determine whether a client name of said client data may be in need of a new mortgage loan or may otherwise be purchasing or financing a new real property, said processor capable of executing instructions for performing a method for identifying potential mortgage borrowers; and
a display module, said display module capable of displaying said listing data, said client data, and said at least one database,
wherein the method for identifying potential mortgage borrowers, when performed on the system, is capable of comparing the client data and the listing data in order to instantaneously identify a plurality of potential mortgage borrowers.

5. The system as claimed in claim 4, wherein said instructions for performing a method for identifying potential mortgage borrowers comprises a borrower identifier, said borrower identifier collecting said listing data and said client data, said borrower identifier storing said listing data and said client data within said at least one database, said borrower identifier matching a client address of said client data with a listing address of said listing data in order to determine whether a client name corresponding to said client address may be in need of a new mortgage loan or may otherwise be purchasing or financing a new real property, said borrower identifier capable of repeating upon collecting at least one of updated said listing data and updated said client data.

6. The system as claimed in claim 5, wherein said borrower identifier notifies at least one third-party that said client name may be in need of a new mortgage loan or may otherwise be purchasing or financing a new real property, and wherein said borrower identifier notifies at least one third-party that said client name may be in need of a good or service associated with purchasing or financing a new real property.

7. The system as claimed in claim 4, wherein said processor executes at least one user command, said at least one user command relating to at least a part of a method for identifying potential mortgage borrowers.

8. The system as claimed in claim 4, wherein said listing data includes at least one listing address.

9. The system as claimed in claim 4, wherein said client data includes at least one of at least one client name and at least one client address.
